(19) United States
(12) Patent Application Publication
(10) Pub. No.: US 2010/0041834 A1
(43) Pub. Date: Feb. 18, 2010

(54) Incorporation of functional groups into polymers using C-H activation

(75) Inventor: Chulsung Bae, Henderson, NV (US)

Correspondence Address: Mark A. Litman & Associates, P.A.;York Business Center, Ste. 205, 3209 West 76th Street, Edina, MN, 55435, US

(73) Assignee: The Board of Regents of the Nevada System of Higher Education on Behalf of the UNLV

(21) Appl. No.: 12/587,959

(22) Filed: Oct. 15, 2009

Related U.S. Application Data
(63) Continuation-in-part of application No. 12/080,372, filed on Apr. 2, 2008.
(60) Provisional application No. 61/200,257, filed on Nov. 26, 2008.
(60) Provisional application No. 60/921,459, filed on Apr. 2, 2007.

(51) Int. Cl. C08G 79/08

(52) U.S. Cl. 525/389

(57) ABSTRACT

Designed functionality is incorporated onto a preformed aromatic polymer. The preformed aromatic polymer is provided in a reactive medium. Within that reactive medium is provided a borylation reagent and a catalyst for C—H borylation. A; and a C—H position on an aromatic ring on the preformed aromatic polymer is catalytically borylated with the borylating agent to form a borylated aromatic moiety on the preformed aromatic polymer as an incorporated boryl functionality. That boryl functionality may then be reacted with designed alternative functionalities.

### RELATED APPLICATIONS DATA SECTION

The present Application claims priority from U.S. Provisional Patent Application 61/200,257, filed Nov. 26, 2008, which in turn claims priority as a continuation-in-part Application of U.S. patent application Ser. No. 12/080,372, filed Apr. 2, 2008 (titled MODIFICATION OF POLYMERS HAVING PENDANT AROMATIC GROUPS THROUGH FORMATION OF BORONIC ESTER GROUPS) which in turn claims priority from Provisional U.S. Patent Application Ser. No. 60/921,459, filed Apr. 2, 2007.

### BACKGROUND OF THE INVENTION

1. Field of the Invention

The present invention relates to polymers, polymer chemistry, chemical modification polymers, modification of properties of polymers by chemical reactions with the polymer.

2. Background of the Art

The aromatic ring moiety is a ubiquitous structural element in macromolecular architectures. Aromatic main-chain polymers in particular constitute a majority of engineering thermoplastics because they have excellent chemical stability and thermal stability as well as mechanical strength. The introduction of functional groups into the aromatic main-chain polymer allows the creation of high-performance materials with specific functional abilities, durability under desired circumstances and a wider scope of potential fields for applications. For example, functionalized polysulfones have been actively investigated as membrane materials for liquid and gas separation and fuel cells and the desire for the addition of specific additional functionalities in that environment and other environments would be particularly desirable.

The introduction of functionality into aromatic polymers such as polysulfone can occur via copolymerization with a functionalized comonomer or postfunctionalization of the polymer. Although several fuctionalized comonomers have been used in the former approach, the reduced reactivity of the comonomer during condensation polymerization generally resulted in low-molecular-weight polymers (Bottino, F. A.; Mamo, A.; Recca, A.; Brady, J.; Street, A. C.; McGrail, P. T. Polymer 1993, 34, 2901-2902). In addition, some functionalities would be incompatible with the polymerization conditions because the nucleophilic aromatic substitution polymerization is generally conducted at elevated temperature (>150° C.) for an extended time (>12 h). In the latter approach, several modifications of polysulfone using sulfonation (Iojoiu, C.; Maréchal, M.; Chabert, F.; Sanchez, J. -Y. Fuel Cells 2005, 5, 344-354), bromination (Guiver, M. D.; Kutowy, O.; ApSimon, J. W. Polymer 1989, 30, 1137-1142), chloromethylation (Warshawsky, A.; Kahana, N.; Deshe, A.; Gottlierb, H. E.; Arad-Yellin, R. J. Polym. Sci. Part A: Polym. Chem. 1990, 28, 2885-2905), amidoalkylation (Kahana, N.; Arad-Yellin, R.; Deshe, A.; Warshawsky, A. J. Polym. Sci. Part A: Polym. Chem. 1990, 28, 3303-3315), and lithiation (Guiver, M. D.; ApSimon, J. W.; Kutowy, O. J. Polym. Sci. Polym. Lett. Ed. 1988, 26, 123-127) have been developed, but most of them require chemical conditions that are quite severe and can possibly damage internal polymer structure. Great care is needed to avoid undesirable side reactions such as cross-linking and chain scission, which can alter the molecular weight and reduce the favorable properties of aromatic polymers, and particularly the polysulfone class of polymers. Hence, alternative mild methods to introduce functionality to polysulfone are highly desired.

Published U.S. Patent Document No. 2004/0024237 (Maleczka) discloses “Synthesis of aminoarylboronic esters and substituted anilines from arenes via catalytic C—H activation/borylation/amination and uses thereof.” This is a process for synthesizing aminoarylboronic esters of the general formula 1 wherein R, R.₂ and R₃ are each an alkyl, aryl, vinyl, alkoxy, carboxylic esters, amides, or halogen; Ar is any variety of phenyl, naphthyl, anthracyl, heteroaryl; and R₁ is alkyl, hydrogen, or aryl. The aminoarylboronic esters are produced via the metal-catalyzed coupling of arylboronic esters of the general formula 2 wherein R and R₁ are any non-interfering group and X is chloro, bromo, iodo, triflates, or nonaflates to amines (primary and secondary). In particular, a process is described for the synthesis of the aminoarylboronic esters via a step-wise or tandem process in which one catalytic event is a metal-catalyzed borylation and the other catalytic event is a metal-catalyzed amination.

Published U.S. Patent Document No. 2004/0030197 (Maleeczka) discloses process to synthesize substituted phenols such as those of the general formula RR′R″Ar(OH) wherein R, R′, and R″ are each independently hydrogen or any group which does not interfere in the process for synthesizing the substituted phenol including, but not limited to, halo, alkyl, alkoxy, carboxylic ester, amine, amide; and Ar is any variety of aryl or hetroaryl by means of oxidation of substituted arylboronic esters is described. In particular, a metal-catalyzed C—H activation/borylation reaction is described, which when followed by direct oxidation in a single or separate reaction vessel affords phenols without the need for any intermediate manipulations. More particularly, a process wherein Ir-catalyzed borylation of arenes using pinacolborane (HBPin) followed by oxidation of the intermediate arylboronic ester by OXONE is described.

Each of these references cited herein are incorporated by reference in their entirety for background and enabling disclosure of processes, equipment, materials and conditions used in these and related processes.

### SUMMARY OF THE INVENTION

The technology described herein includes materials and a generic process for synthesizing those materials.

The process is generically described as a method for providing or forming incorporation of a functionality onto a chemical compound and preferably a preformed aromatic polymer. The process may include steps such as providing the preformed aromatic polymer into a reactive medium; within that reactive medium providing a borylation reagent and a catalyst for C—H borylation; and catalytically borylating a C—H position on an aromatic ring on the preformed aromatic polymer with the borylating agent to form a borylated aromatic moiety on the preformed aromatic polymer.

A controlled, highly efficient conversion of the C—H bonds of the aromatic ring of aromatic polymers (Poly-Ar of Scheme 1) into desired functional groups via boron-functionalized intermediate polymer (Poly-B of Scheme 1) is described and enabled herein. The general strategy of this technology is generally exemplified in Scheme 1, which may be expanded upon by those skilled in the art and enabled by the present disclosure beyond the strict limits of the literal schematic.

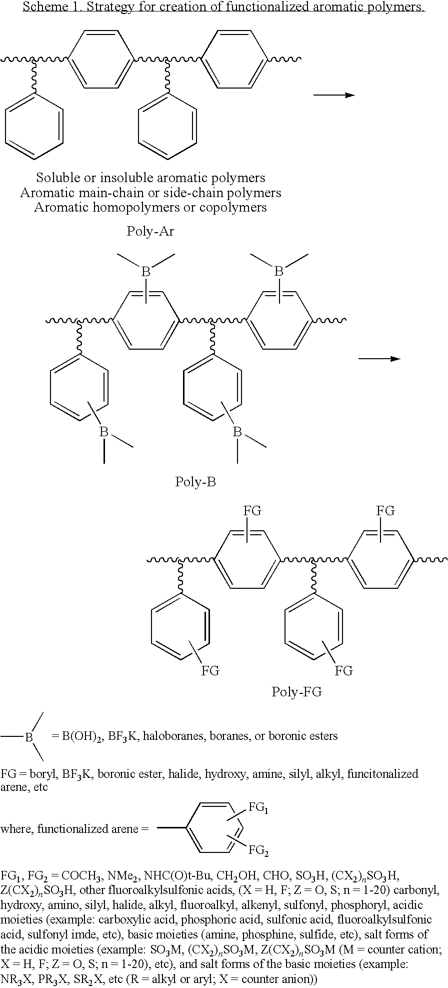

This scheme thereon may therefore be generally described as reacting a first boronic moiety (any compound, species or moiety reacted to the aromatic ring directly through a boron atom) with a backbone and/or pendant aromatic ring in an aromatic polymer to form an attached boronic species and then either leaving the attached boronic species as the reactive group on the aromatic group to which it has been bonded, and/or reacting additional species to the attached boronic species to add functionality through the further reacted boronic species, or replacing existing groups on the attached boronic species with alternative reactive species (e.g., the halide, hydroxyl, amine, silyl, alkyl and especially substituted alkyl with specific reactive groups thereon), functionalized arene (arene, aryl or arylene groups and/or arene groups have reactive moieties or groups thereon, as described above).

This new polymer modification methodology can be applied to aromatic polymer system where the structural unit is made of aromatic rings in pendant or backbone groups, and by way of non-limiting example, number average molecular weight (Mₙ)=1,000-1,000,000 g/mol. The aromatic ring of a cross-linked polystyrene, so called polystyrene resin and polystyrene bead, also can be functionalized with this method.

The intermediate polymer (Poly-B) can be prepared by (a) transition metal catalyzed activation/borylation of aromatic C—H bond (as described and referenced later herein) of Poly-Ar, (b) lithiation of Poly-Ar (Guiver, M. D.; ApSimon, J. W.; Kutowy, O. J. Polym. Sci. Polym. Lett. Ed. 1988, 26, 123-127) followed by subsequent reaction with boron reagent (Chan, K. L.; McKieman, M. J.; Towns, C. R.; Holmes, A. B. J. Am. Chem. Soc. 2005, 127, 7662-7663), or (c) halogenation (or pseudo halogenation) at the aromatic ring of Poly-Ar followed by subsequent conversion of halide (or pseudo halide) to boron using the above-referenced lithiation or transition metal catalyzed boronation (Ishiyama, T.; Murata, M.; Miyaura, N. J. Org. Chem. 1995, 60, 7508-7510). The boron functionality in Poly-B includes but not limited to boronic acid (—B(OH)₂), potassium trifluoroborate (—BF₃K), haloborane (—BX₂, X=halide), borane (—BH₂ or —BR₂, where R=alkyl), boronic ester (—B(OR)₂, R=alkyl).

The functionalized aromatic polymer (Poly-FG of Scheme 1) can be synthesized by subsequent reactions of the boryl group (boronic moiety) in Poly-B. Examples of functional group include but not limited to boronic acid (—B(OH)₂), potassium trifluoroborate (—BF₃K), haloborane (—BX₂, X=halide), borane (—BH₂ or —BR₂, where R=alkyl), boronic ester (—B(OR)₂, R=alkyl), halide, hydroxy (—OH), amine (—NR₂, R═H or alkyl), silyl (—SiR₃, R=alkyl), siloxy (—SiOR, R=alkyl), alkyl, and aromatic ring containing various functionalities (FG₁ and FG₂ of Scheme 1). Poly-FG can be also prepared by cross-coupling reaction of Poly-B and functionalized aryl halide (or pseudo halide) which contains various functionalities (FG₁ and FG2 of Scheme 1).

### BRIEF DESCRIPTION OF THE FIGURES

FIG. 1. This Figure shows ¹H NMR spectra of borylated polysulfone (delay time=1 s; number of scans=16. An asterisk indicates H₂O from NMR solvent): (a) 46% PSU—B(pin) (entry 2 of Table 1, 10 mg/mL in CDCl₃); (b) 176% PSU—B(pin) (entry 6 of Table 1, 10 mg/mL in CDCl₃).

FIG. 2. This Figure shows ¹³C NMR spectrum [delay time=4 s, number of scans=7000] of 46% PSU—B(pin) [entry 2 of Table 1, 40 mg/mL in CDCl₃ at 25° C.].

FIG. 3. This figure shows size exclusion chromatography of (a) PSU; (b) 46% PSU—B(pin) (Table 1, entry 2); (c) 176% PSU—B(pin) (Table 1 entry 6); (d) 224% PSU—B(pin) (Table 1, entry 8). (Right) Evolutions of Mₙ and PDI vs. the amount of B₂(pin)₂ added relative to PSU.

FIG. 4. This Figure shows ¹¹B NMR spectrum [delay time=4 s, number of scans=1000] of 46% PSU—B(pin) [entry 2 of Table 1, 40 mg/mL in CDCl₃ at 25° C.].

FIG. 5. This Figure shows ¹H NMR spectra of Suzuki-Miyaura coupled polysulfones (delay time=1 s, number of scans=16, concentration=10 mg/mL in CDCl₃. An asterisk indicates H₂O from NMR solvent): (a) PSU—COCH₃ (entry 1 of Table 2); (b) PSU—NMe₂ (entry 3 of Table 2); (c) PSU—NHBoc (entry 5 of Table 2); (d) PSU—CH₂OH (entry 7 of Table 2); (e) PSU—CHO (entry 9 of Table 2).

### DETAILED DESCRIPTION OF THE INVENTION

The technology described herein includes materials and a generic process for synthesizing those materials.

The process is generically described as a method for providing or forming incorporation of a functionality onto a preformed aromatic polymer. By “preformed polymer” is meant that at least some substantial chain length (e.g., at least 4 monomeric moieties have already been joined and preferably the polymer has a molecular weight of at least 10,000 (number average or weight average molecular weight at the convenience of the tester), at least 25,000, at least 50,000 or at least 75,000 at the time that the functionalization process is begun. That is, the functionalization process is not begun at the same time that at least 20% of monomeric polymerizable substituents are still available in the material for primary polymerization from monomeric forms. The process may include steps such as providing the preformed aromatic polymer into a reactive medium; within that reactive medium providing a borylation reagent and a catalyst for C—H borylation; and catalytically borylating a C—H position on an aromatic ring on the preformed aromatic polymer with the borylating agent for form a borylated aromatic moiety on the preformed aromatic polymer. The borylation may be provided in a wide range of at least a temperature above −100° C., between −100 to 200° C., a temperature of between −100 to 180° C. for greater than one-half hour or at a temperature of between −100 to 180° C. for greater than 12 hours. The catalyst is preferably selected from the group consisting of Ir-catalysts, Re-catalysts, Pd-catalyst, Pt-catalyst, Ru-catalyst, Rh-catalyst and mixtures thereof. One result of the process may be effected preferably where at least 10% total molecular weight of the preformed aromatic polymer comprises aromatic groups. The process is preferably performed on a polysulfone or polystyrene polymer. One preferred class of product of the process may have at least 1%, at least 2% or at least 5% of total molecular weight of the polymer product consisting of borylated aromatic moiety. One further extension of the process is where after forming the borylated moiety, at least some borylated moiety is further reacted to alter the chemical functionality of the borylated moiety.

The introduction of functionality into any aromatic polymer (by definition, any polymer having backbone aromatic groups or pendant aromatic groups, especially where those aromatic groups comprise at least 10%, preferably at least 25%, and most preferably at least 40% by weight of the total molecular weight of the aromatic polymer), and preferably polysulfone, can occur via copolymerization with a functionalized comonomer or post-functionalization of the polymer. Although several functionalized comonomers have been used in the former approach, the reduced reactivity of the comonomer during condensation polymerization generally resulted in low-molecular-weight polymers. In addition, some functionalities would be incompatible with the polymerization conditions because the nucleophilic aromatic substitution polymerization is generally conducted at elevated temperature (0 to 290° C., >150° C.) for an extended time (at least 15 minutes, preferably 0.5-20 hours, more preferably >12 hours, with no functional upper limit except by judgment). In the latter approach, several modifications of polysulfone using sulfonation, bromination, chloromethylation, amidoalkylation, and lithiation have been developed, but most of them require chemical conditions that are quite severe. Great care is needed to avoid undesirable side reactions such as cross-linking and chain scission, which can alter the molecular weight and reduce the favorable properties of polysulfone. Hence, alternative mild methods to introduce functionality to polysulfone are highly desired.

This new polymer modification methodology enabled herein can be applied to any aromatic polymer system, either soluble or insoluble polymer, as long as the structural unit has at least some aromatic rings. The major advantage of this postfunctionalization process is that various functional groups with specific concentrations can be incorporated into the aromatic ring of the polymer main chain under mild conditions without causing chain cleavage or cross-linking of polymer chains.

Because various functional groups can be attached to aromatic polymer in a convenient way, the scope of materials that can be prepared by this method is enormously broad. For example, polysulfones containing sulfonic acid (—SO₃H) or fluoroalkylsulfonic acid (—(CF₂)ₙSO₃H) would have potential applications in membrane materials for fuel cells, biofuel production, water purification, water electrolysis, gas/liquid separation, ion transportation, ion conducting actuator and the like.

Functionalization of aromatic polysulfone, an aromatic backbone polymer, using a combination of iridium-catalyzed activation/borylation of the aromatic C—H bond (Ishiyama, T.; Takagi, J.; Ishida, K.; Miyaura, N.; Anastasi, N. R.; Hartwig, J. F. J. Am. Chem. Soc. 2002, 124, 390-391) and Suzuki-Miyaura cross-coupling reaction (Miyaura, N.; Suzuki, A. Chem. Rev. 1995, 95, 2457-2483) is described below as a representative example (Scheme 2). However, it should be emphasized that (a) this methodology can be applied to any aromatic polymer system, either as a soluble or insoluble polymer, as long as the structural unit is made of aromatic rings, (b) the functional groups that can be incorporated into the aromatic polymer are not limited to examples shown in Scheme 2. The broader scope and more comprehensive examples of functional group are listed in Scheme 1. The major advantage of this postfunctionalization process is that various functional groups with specific concentrations can be incorporated into the aromatic ring of the polymer main chain under mild conditions without causing chain cleavage or cross-linking of polymer chains.

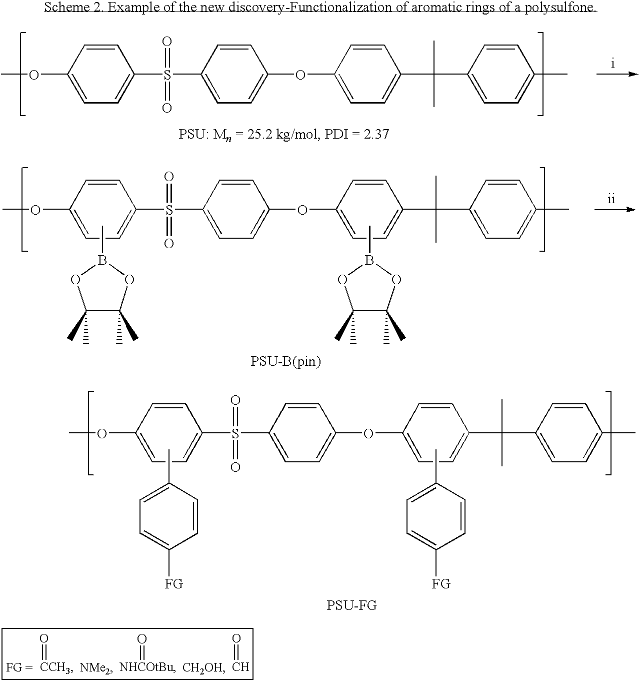

Reagents and conditions: (i) B₂(Pin)₂, 1.5% [IrCl(COD)]₂, 3% dtbpy, THF, 80° C., 12 h; (ii) p-Br—C₆H₄—FG, 3% Pd(PPh₃)₄, 3 equiv K₂CO₃, THF/H₂O (10:1), 80° C., 6 h.

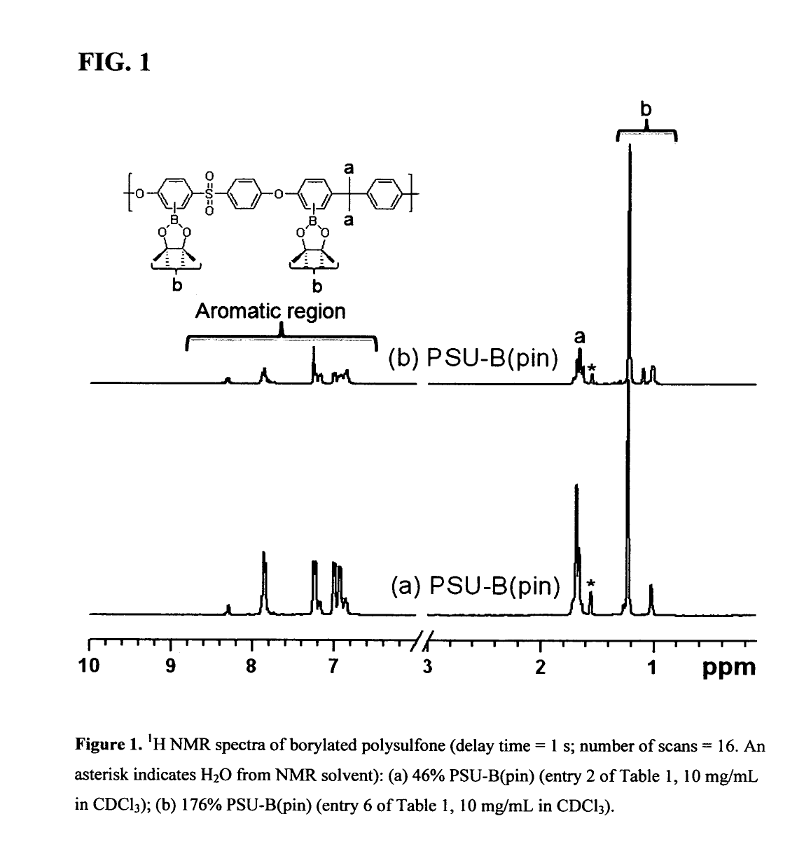

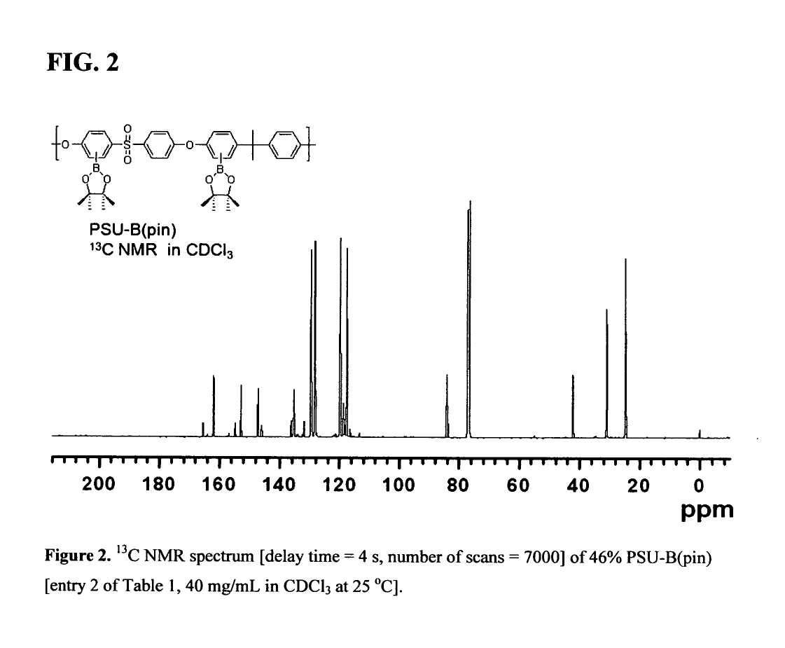

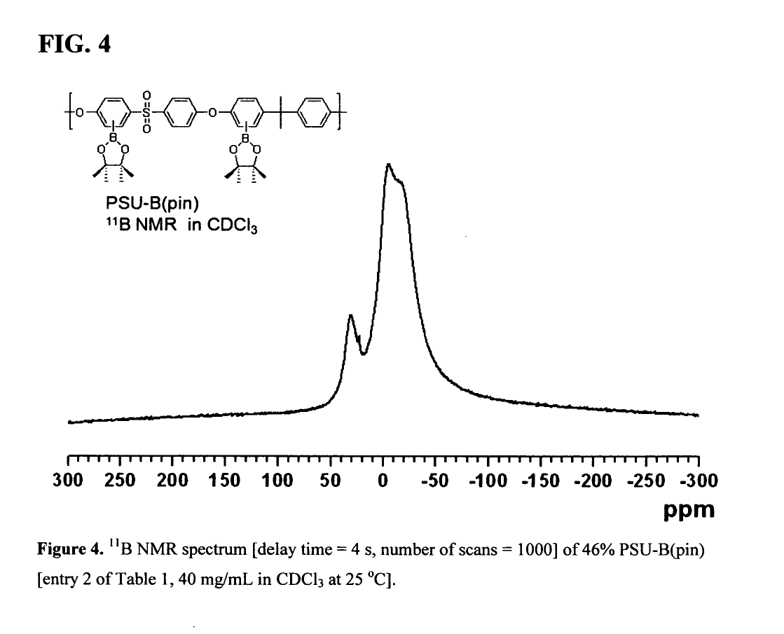

The iridium-catalyzed reaction (or other suitable catalyst for the catalyzed reaction with the boronic moiety) of a commercial polysulfone [PSU: Mₙ=25.2 kg/mol; PDI (M_{w}/Mₙ)=2.37] with different molar ratios of, for example, the bis(pinacolato)diboron [B₂(pin)₂] to polymer repeating unit in THF yielded the corresponding pinacolboronate-functionalized polymer [PSU—B(pin)] (Scheme 2). ¹H NMR spectra of all PSU—B(pin) showed distinctive new resonances at 1.0-1.2 ppm for the four methyl groups of pinacolboronate ester [B(pin)] (FIG. 1 in supporting figures). The ¹³C NMR spectrum of PSU—B(pin) exhibited two distinct resonances at 24 and 84 ppm, corresponding to the four methyl groups and the quaternary carbon of the B(pin) group, respectively (FIG. 2 in supporting figures). The ¹¹B NMR spectrum also displayed a broad peak at approximately 30 ppm, which was in good agreement with the chemical shift of the B(pin)-functionalized polystyrene (FIG. 4 in supporting figures). The iridium-catalyzed borylation substitutes only the aromatic C—H bonds of arene and polystyrene. Thus, the mol % of the attached B(pin) group per PSU repeating unit was calculated by comparing the proton resonance integrals of the isopropylidene group in the polymer main chain (at 1.69 ppm) and the four methyl groups of the B(pin). The mol % of B(pin) attached to the polymer varied in proportion to the amount of B₂(pin)₂ added (Table 1). The efficiency of C—H borylation, defined as the amount of B(pin) attached to the polymer divided by the amount of boron atom added, was 60-70% in most cases, allowing the degree of borylation to be conveniently controlled using stoichiometric tuning of the amount of B₂(pin)₂ added.

TABLE 1
Iridium-catalyzed C—H borylation of polysulfone.

| Entry | Ratio^{a} | B(pin) (%)^{b} | Effic. (%)^{c} | Mₙ^{d} | PDI | IV^{e} |
|---|---|---|---|---|---|---|
| 1 | 0.2 | 14 | 34 | 26.4 | 2.29 | 0.77 |
| 2 | 0.4 | 46 | 57 | 26.9 | 2.25 | 0.79 |
| 3 | 0.6 | 73 | 61 | 27.7 | 2.29 | 0.86 |
| 4 | 0.8 | 108 | 68 | 28.5 | 2.30 | 0.89 |
| 5 | 1.0 | 138 | 69 | 30.2 | 2.31 | 0.93 |
| 6 | 1.2 | 176 | 74 | 31.6 | 2.50 | 1.01 |
| 7 | 1.4 | 196 | 70 | 32.6 | 2.30 | 1.02 |
| 8 | 1.6 | 224 | 70 | 33.1 | 2.33 | 1.05 |

^{a}Initial ratio of B₂(pin)₂ to PSU repeating unit.
^{b}The mol % of B(pin) attached to PSU based on ¹H NMR spectra
^{c}Efficiency (%) of C—H borylation: the amount of B(pin) attached to the polymer divided by the amount of boron atom added.
^{d}Number-average molecular weight reported in kg/mol. PSU has Mₙ of 25.2 kg/mol and PDI of 2.37.
^{e}Intrinsic viscosity measured using an Ubbelohde ™ viscometer at 30° C. with a polymer concentration of 0.5 g/dL in chloroform (PSU has IV of 0.60 dL/g).

PSU has four different aromatic C—H bonds in the repeating unit; two in the aryl sulfone unit and two in the bisphenol A unit. Thus the C—H borylation of PSU can, in principle, generate a mixture of four different regioisomers of B(pin)-functionalized polymer. The ¹H NMR spectrum of 46% PSU—B(pin) (Table 1, entry 2) showed two proton resonances of the B(pin) group at 1.03 and 1.23 ppm, with an integral ratio of 1.0:5.6. PSU—B(pin) with higher than 100% B(pin) concentration begins to show an additional minor resonance of B(pin) group at 1.11 ppm (FIG. 1 in supporting figures). These results indirectly indicate the formation of multiple regioisomers with an unequal population. Although these results need further study, we speculate that the aromatic ring in the aryl sulfone repeating unit is borylated preferably owing to the favored electronic effect.

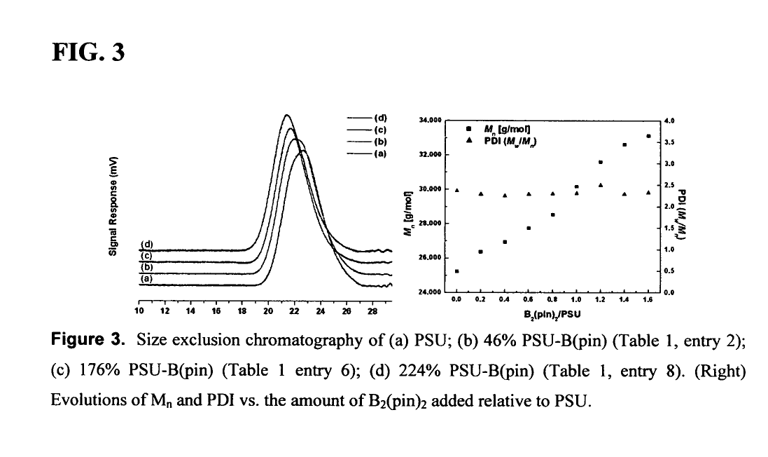

To investigate whether undesirable side reactions that could affect the molecular weight of the polymer have occurred during the C—H activation process, we measured the Mₙ and PDI of PSU—B(pin) using size exclusion chromatography. As shown in Table 1 and FIG. 3, an increase in the ratio of B₂(pin)₂ to the polymer resulted in an increased Mₙ of PSU—B(pin) owing to the incorporation of more of the B(pin) moiety into the polymer chain and the corresponding hydrodynamic volume increase. All PDIs, however, remained consistently at approximately 2.30 even with the incorporation of 224% B(pin) (Table 1, entry 8), suggesting a complete absence of cleavage or cross-linking of the polymer chains. A gradual increase in molecular weights owing to the attachment of more B(pin) group was also reflected in the intrinsic viscosity measurement of PSU—Bpin (see Table 1).

FIG. 3 shows size exclusion chromatography of (a) PSU; (b) 46% PSU—B(pin) (Table 1, entry 2); (c) 176% PSU—B(pin) (Table 1 entry 6); (d) 224% PSU—B(pin) (Table 1, entry 8). (Right) Evolutions of Mₙ and PDI vs. the amount of B₂(Pin)₂ added relative to PSU.

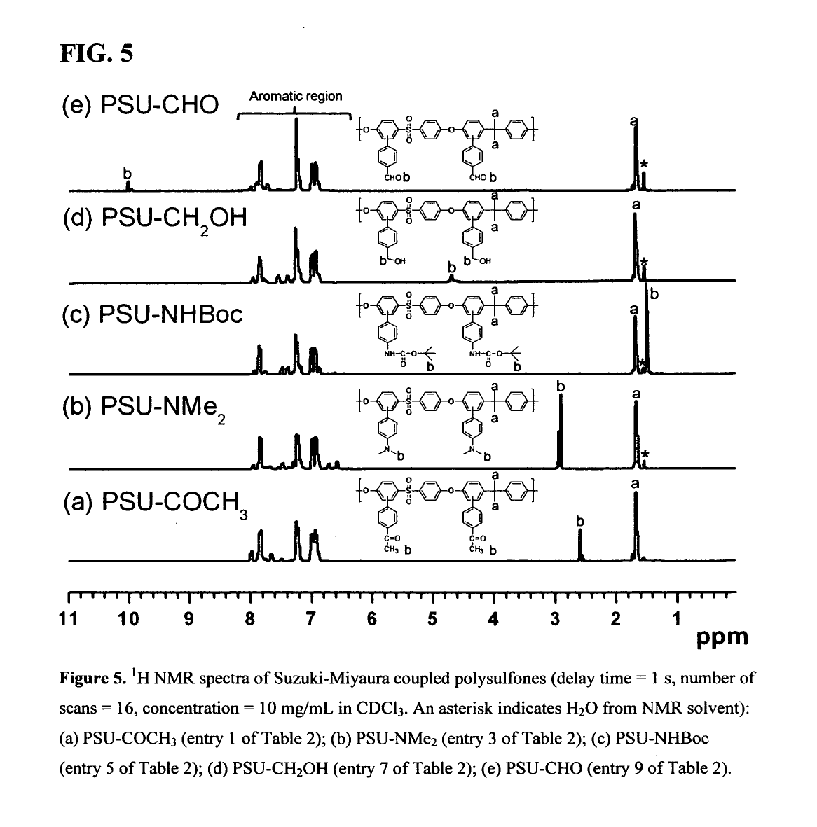

Because aryl pinacolboronate is an effective substrate in the Suzuki-Miyaura cross-coupling reaction, by which various functional groups can be introduced via biaryl C—C bond formation, PSU—Bpin can serve as a fruitful precursor for the generation of PSUs containing a diverse range of functional groups. To explore this possibility, we took PSU—B(pin) with two different mol % (46% of entry 2 and 176% of entry 6 in Table 1) and coupled them with aryl bromides containing ketone, amine, Boc-protected amine, hydroxy, and aldehyde using 3% Pd(PPh₃)₄ catalyst (Scheme 2). The ¹H NMR analysis of the polymer products from the Suzuki-Miyaura reaction (PSU—FG) revealed that the proton resonances of the B(pin) moiety disappeared completely, and a new set of resonances from the arene functionality (FG in Scheme 1) appeared with almost identical concentrations (Table 2 and FIG. 5 in supporting figures). Thus, by presetting the B(pin) concentration in the C—H borylation step we can incorporate desired functionality with a specific concentration, underscoring the usefulness of this postfunctionalization method.

TABLE 2
Suzuki-Miyaura cross-coupling reactions of PSU-B(pin)

| Entry | FG | FG (%)^{c} | Mₙ^{d} | PDI | IV^{e} |
|---|---|---|---|---|---|
| 1^{a} | COCH₃ | 47 | 26.1 | 2.35 | 0.77 |
| 2^{b} | | 194 | 32.3 | 2.27 | 1.01 |
| 3^{a} | NMe₂ | 48 | 33.9 | 2.41 | 0.76 |
| 4^{b} | | 171 | 47.4 | 2.72 | 1.01 |
| 5^{a} | NHBoc^{f} | 46 | 26.6 | 2.24 | 0.74 |
| 6^{b} | | 177 | 33.7 | 2.58 | 1.00 |
| 7^{a} | CH₂OH | 46 | 34.5 | 2.59 | 0.89 |
| 8^{b} | | 172 | 43.6 | 2.40 | 0.91^{g} |
| 9^{a} | CHO | 47 | 34.4 | 2.88 | 0.76 |
| 10^{b} | | 177 | 42.9 | 2.62 | 1.00 |

^{a}From 46% borylated PSU-B(pin) (Table 1, entry 2).
^{b}From 176% borylated PSU-B(pin) (Table 1, entry 6).
^{c}The mol % of FG functionality attached to PSU based on ¹H NMR spectra.
^{d}Number-average molecular weight reported in kg/mol.
^{e}Intrinsic viscosity measured using an Ubbelohde viscometer at 30° C. with a polymer concentration of 0.5 g/dL in chloroform.
^{f}Boc = t-butoxycarbonyl.
^{g}Measured in DMAc at 30° C.

Similar to the results of PSU—B(pin), the molecular weight properties (Mₙ, PDI, intrinsic viscosity) of PSU—FG were essentially unchanged from those of the precursor polymers, indicating that no polymer chain scission or cross-linking occurred (see Table 2).

We have demonstrated a new synthetic method for the introduction of functional groups into aromatic polysulfone using a combination of an iridium-catalyzed C—H activation/borylation and the Suzuki-Miyaura reaction. The concentration of attached B(pin) group was controlled simply by adjusting the stoichiometry of the diboron reagent in the borylation. Subsequent cross-coupling with aryl bromide yielded PSU—FG containing a specific level of desired functional group. Unlike most PSU postfunctionalization processes, this new method proceeds without negatively affecting polymer chain length. This highly efficient and mild postfunctionalization method allows the convenient preparation of a new family of functionalized polysulfones, which can ultimately find broader applications as new high-performance engineering plastic materials.

The aromatic polymers may contain aromatic ring either in polymer side chain (e.g., polystyrene) or in polymer main chain (e.g., polysulfone). The aromatic polymers used herein may be soluble polymers, insoluble polymers (e.g., cross-linked polystyrene), homopolymers, and copolymers.

The functional groups that can be incorporated into aromatic polymer using this discovery include but not limited to boronic acid (—B(OH)₂), potassium trifluoroborate (—BF₃K), halobroane (—BX₂, X=halide), borane (—BH₂ or —BR₂, where R=alkyl), boronic ester (—B(OR)₂, R=alkyl), halide, pseudo halide, hydroxy (—OH), amine (—NR₂, R═H or alkyl), silyl (—SiR₃, R=alkyl), siloxy (—SiR₂OR, R=alkyl), carbonyl, alkyl, fluoroalkyl, alkenyl, alkynyl, ether, sulfide, epoxide, boryl, sulfonyl, sulfonate, phosphoryl, phosphate, acidic moiety (carboxylic acid, phosphoric acid, sulfonimide acid, sulfonic acid, alkylsulfonic acid, fluoroalkylsulfonic acid, etc), salt forms of the acidic moieties, basic moiety, salt forms of basic moieties (ammonium salt, phosphonium salt, sulfonium salt, etc).

The catalysts used herein for borylation of C—H bond, by way of non-limiting examples, may be iridium based catalysts (Ir-catalysts), Re-catalysts, Pd-catalyst, Pt-catalyst, Ru-catalyst, and Rh-catalysts, and mixtures thereof. The iridium-containing catalyst used in the present invention may be any such catalyst provided it is a compound that contains iridium (Ir), the iridium-containing catalyst is preferably a catalyst represented by the following general formula:

IrABn

composed of a cation portion represented by Ir, an anion portion represented by A and an alkene portion represented by B. More preferably, the anion portion represented by A is a chlorine atom, alkoxy group, hydroxyl group or phenyloxy group which may or may not have a substituent, B is an alkene-containing compound such as COD (1,5-cyclooctadiene), COE (1-cyclooctene) or indene, and n is 1 or 2. Specific examples include IrCl(COD), IrCl(COE)₂, Ir(OMe)(COD), Ir(OH)(COD) and Ir(OPh)(COD). The amount used is 1/100000 to 1 mole, and preferably 1/10000 mole to 1/10 mole, with respect to bis(pinacolato)diboron or pinacol borane.

Although there are no particular restrictions on the ligand in these catalysts provided it is a Lewis base having the ability to coordinate to an iridium-containing catalyst, it is preferably a bidentate Lewis base compound, and more preferably, a compound represented with a partial structure of bipyridine which may or may not have symmetric or asymmetric substitution such as hydrogen atom, linear or branched C₁₋₈ alkyl group, linear or branched C₁₋₈ alkoxy group, nitro group, cyano group, halogenated C₁₋₈ alkyl group, halogen atom, carbamoyl group, C₁₋₈ acyl group, C₁₋₈ alkoxycarbonyl group or amino group which may or may not have a substituent, or in which substitution at position 6 and position 6′ may include a hydrogen atom, linear or branched C₁₋₈ alkyl group, linear or branched C₁₋₈ alkoxy group, nitro group, cyano group, halogenated C₁₋₈ alkyl group, halogen atom, carbamoyl group, C₁₋₈ acyl group, C₁₋₈ alkoxycarbonyl group, or amino group which may or may not have a substituent), specific examples of which include trialkyl phosphines such as triphenyl phosphine and tributyl phosphine; ethylenediamines such as tetramethylethylenediamine and ethylenediamine; bipyridines such as 4,4′-di-t-butyl bipyridine, 2,2′-bipyridine, 4,4′-di-methoxy bipyridine, 4,4′-bis(dimethylamino)bipyridine, 4,4′-dichlorobipyridine and 4,4′-dinitrobipyridine, and 1,10-phenanthroline, and preferable specific examples including bipyridines such as 4,4′-di-t-butyl bipyridine, 2,2′-bipyridine, 4,4′-di-methoxybipyridine, 4,4′-bis(dimethylamino)bipyridine, 4,4′-dichlorobipyridine and 4,4′-dinitrobipyridine. The amount used is 1/100000 mole to 1 mole, and preferably 1/10000 mole to 1/10 mole, with respect to bis(pinacolato)diboron or pinacolborane.

There are no particular restrictions on the solvent used in the present invention provided it does not have an effect on the reaction, and examples of such solvents include hydrocarbons such as octane, pentane, heptane and hexane; amides such as N,N-dimethylformamide and N,N-dimethylacetamide; pyrrolidones such as N-methyl-2-pyrrolidone; ketones and sulfoxides such as acetone, ethyl methyl ketone and dimethylsulfoxide; aromatic hydrocarbons such as mesitylene; nitrites such as acetonitrile; ethers such as diisopropyl ether, tetrahydrofuran, 1,4-dioxane, 1,2-dimethoxyethane and anisole; and alcohols such as methanol, ethanol, propanol, ethylene glycol and propylene glycol; with hydrocarbons such as octane, pentane, heptane and hexane being preferable. The reaction is carried out within a temperature range of −100 to 200° C., −100 to 180° C., and preferably −80 to 150° C.

The technology described herein provides polymers that are potentially useful in the following applications, where functionalized polystyrene- and polysulfone-based materials are currently used: (a) Active filtration media in chromatographic systems, (b) Recoverable/recyclable polymer-metal catalyst systems, (c) Polymer supports, (either soluble or insoluble) in organic reactions, combinatorial chemistry, and drug discovery development, (d) Additives to polymer blends, (e) Membrane materials for fuel cells, biofuel production, water purification, water electrolysis, gas/liquid separation, ion transportation, ion conducting actuator, (f) Engineering plastics with robust mechanical strength and high thermal and chemical stability, and (g) Precursor polymers that can be used for creation of various functionalized aromatic polymers.

1. A process for forming incorporation of a functionality onto a preformed aromatic polymer comprising:
providing the preformed aromatic polymer into a reactive medium;
within that reactive medium providing a borylation reagent and a catalyst for C—H borylation; and
catalytically borylating a C—H position on an aromatic ring on the preformed aromatic polymer with the borylating agent to form a borylated aromatic moiety on the preformed aromatic polymer with a boryl functionality.

2. The process of claim 1 wherein the boryl functionality is selected from the group consisting of boronic acid, potassium trifluoroborate, haloborane and borane.

3. The process of claim 1 wherein the catalytic borylation is performed at a temperature above −100° C.

4. The process of claim 2 wherein the catalytic borylation is performed at a temperature of between −100° C. to 200° C.

5. The process of claim 2 wherein the catalytic borylation is performed at a temperature of between −100 to 180° C. for greater than one-half hour.

6. The process of claim 1 wherein the catalytic borylation is performed at a temperature of between −100 to 180° C. for greater than 12 hours.

7. The process of claim 3 wherein the catalyst is selected from the group consisting of Ir-catalysts, Re-catalysts, Pd-catalyst, Pt-catalyst, Ru-catalyst, Rh-catalyst and mixtures thereof.

8. The process of claim 2 wherein at least 10% total molecular weight of the preformed aromatic polymer comprises aromatic groups.

9. The process of claim 8 wherein the catalyst comprises an iridium catalyst represented by the formula:
IrABn
wherein Ir represents a cationic iridium atom, and A represents an anionic moiety and B represents an alkene moiety.

10. The process of claim 9 wherein A is selected from the group consisting of chlorine atom, alkoxy group, hydroxyl group phenyloxy group and substituted phenyloxy group, and B is an alkene-containing compound and n is 1 or 2.

11. The process of claim 7 wherein the aromatic polymer comprises a polysulfone.

12. The process of claim 8 wherein the aromatic polymer comprises a polysulfone.

13. The process of claim 9 wherein the aromatic polymer comprises a polysulfone.

14. The process of claim 10 wherein the aromatic polymer comprises a polysulfone.

15. The product of the process of claim 1 having at least 2% of total molecular weight of the product consisting of borylated aromatic moiety.

16. The process of claim 1 where after forming the borylated moiety, at least some borylated moiety is further reacted to alter the chemical functionality of the borylated moiety.

17. The process of claim 11 where after forming the borylated moiety, at least some borylated moiety is further reacted to alter the chemical functionality of the borylated moiety.

18. The process of claim 13 where after forming the borylated moiety, at least some borylated moiety is further reacted to alter the chemical functionality of the borylated moiety.

19. The process of claim 4 wherein the catalyst is selected from the group consisting of Ir-catalysts, Re-catalysts, Pd-catalyst, Pt-catalyst, Ru-catalyst, Rh-catalyst and mixtures thereof and the preformed aromatic polymer comprises polystyrene.

20. The product of the process of claim 8 having at least 2% of total molecular weight of the product consisting or borylated aromatic moiety and the preformed aromatic polymer is selected from the group consisting of polysulfone and polystyrene.
